(19) United States
(12) Patent Application Publication
(10) Pub. No.: US 2013/0332207 A1
(43) Pub. Date: Dec. 12, 2013

(54) System and method for intelligent management of appointment waiting list

(71) Applicants: Benoit Brunel, St-Charles-sur-Richelieu (CA); Annie Blanchette, Varennes (CA); Jean-Francois Turgeon, Chateauguay (CA); Jean Cote, Saint-Constant (CA)

(72) Inventors: Benoit Brunel, St-Charles-sur-Richelieu (CA); Annie Blanchette, Varennes (CA); Jean-Francois Turgeon, Chateauguay (CA); Jean Cote, Saint-Constant (CA)

(21) Appl. No.: 13/493,349

(22) Filed: Jun. 11, 2012

(51) Int. Cl. G06Q 10/02

(52) U.S. Cl. 705/5

(57) ABSTRACT

A system and a method for intelligently managing waiting lists and other similar lists for service providers are disclosed. The system is configured for customer to request the scheduling of at least one appointment, to schedule one or more appointments of a customer, to store the information related to the customer in a database, to manage the different intelligent waiting list and to confirm and notify the customer when an appointment is automatically assign. Generally, the system is configured to be used over a communication network such as the Internet to allow a customer to be electronically notified of the scheduling of an appointment.

### FIELD OF THE INVENTION

The present invention generally relates to the field of systems and/or methods for intelligent management of appointment waiting list, and particularly to enabling automated appointment rescheduling and notification of such rescheduling, thereby minimizing the effort of the service provider's customer service representative and generally improving efficiency of such process.

### BACKGROUND OF THE INVENTION

More than often, a customer having planned an appointment with a service provider needs to reschedule the appointment for personal, professional or medical reasons. Currently, a customer needs to call the appointment representative to ask a rescheduling of the appointment. The representative must then find a new time slot that fits both service provider and customer schedules. It may be impossible to reschedule an appointment if a shortage of available time slots exists. Additionally, if other appointments depend on the rescheduled appointment or could be combined with this appointment, it might be required to reschedule those appointments, making the rescheduling a tedious process.

Furthermore, a scheduled appointment may be cancelled by the service provider for many reasons, such as a schedule modification, the absence of an employee of the service provider or any other unpredictable event. Typically, when such cancellation occurs, the service provider must try to contact the customer in order to notify the customer of the cancellation and to reschedule the appointment. Again, the process is tedious and may be impossible for short notice cancellation. In the event where the customer may not be reached, the customer may needlessly attend to the appointment, thus loosing time and money.

Such processes are time consuming for both the customer and the service provider's representative. Also, the rescheduling process may imply that a representative tries to reassign the appointment to a customer on a waiting list. Again, the reassignment process decreases the efficiency and productivity of the representative. If no customer are present on the waiting list or if the availabilities of the customers on the waiting list do not match the available appointments time periods, the service provider may incur lost of revenues.

There is thus a need for a system and method for intelligent management of appointments waiting lists, so that customers may automatically cancel and reschedule one or more appointment or get notified that the system has automatically assigned an new appointment based on new available time slots, without the customer having to contact by telephone a customer service's representative, and the present invention addresses this need. Furthermore, there is a need for a system and method to automatically notify and reschedule an appointment, even if for short notice appointment cancellation. Also, the invention provides a method and system for waiting customer to be automatically notified using the most appropriate medium of communication of an available appointment.

Other and further objects and advantages of the present invention will be obvious upon an understanding of the illustrative embodiments about to be described or will be indicated in the appended claims, and various advantages not referred to herein will occur to one skilled in the art upon employment of the invention in practise.

### SUMMARY OF THE INVENTION

The aforesaid and other objectives of the present invention are realized by generally providing a method and system for intelligent management of one or more appointment waiting lists. The method for intelligent management of appointment waiting list may comprises at least one step, such step may be requesting a new appointment, scheduling the appointment, adding the name and information of the customer on a waiting list, managing an intelligent waiting list, confirming and notifying the appointee, having the appointment scheduled.

Such method allows a customer to request a new appointment or the rescheduling of an existing appointment. If no time period is available to assign or reschedule an appointment based on the customer's preferences, the customer is placed on a waiting list. In the event of a rescheduling of an appointment, the customer may be placed at his prior position on the waiting list. On assignation or rescheduling of the appointment by the system, the customer may get notified by a communication mean asking the customer to confirm the automatic assignation or rescheduling of the appointment. Such communication mean may be adapted, such as calling the customer instead on sending an email, based on parameters defined within the system such as priority or urgency of the appointment, customer's preferences and dependencies between different appointments.

The method is realized by a system that manages one or more appointment waiting lists. Such system comprises at least one client device, a communication network, at least one web server communicating with at least one application server and with at least one data source.

Within the present document, the terms service provider should include and not be limited to any company, organization, healthcare establishments or governmental services. The term customer should include but not be limited to any user, employee, representative, customer, supplier, partners of a service provider.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a workflow diagram presenting steps of an embodiment of a method for intelligent management of appointment waiting list in accordance with the principles of the present invention.

FIG. 2 is a system diagram of an embodiment of a system for intelligent management of appointment waiting list in accordance with the principles of the present invention.

FIG. 3 is a workflow diagram presenting a request of a new appointment by a customer in accordance with the principles of the present invention.

FIG. 4 is a workflow diagram presenting a process to schedule an appointment in accordance with the principles of the present invention.

FIG. 5 is a workflow diagram presenting a process managing intelligent waiting list using the system and method in accordance with the principles of the present invention.

FIG. 6 is a workflow diagram presenting a method and process for managing intelligent waiting list using a patience level in accordance with the principles of the present invention.

### DETAILED DESCRIPTION OF THE PREFERRED EMBODIMENT

A novel system and method for intelligent management of appointment waiting lists will be described hereinafter. Although the invention is described in terms of specific illustrative embodiments, it is to be understood that the embodiments described herein are by way of example only and that the scope of the invention is not intended to be limited thereby.

The preferred embodiments of the present invention are described below with reference to the drawing figures where like numerals represent like elements throughout.

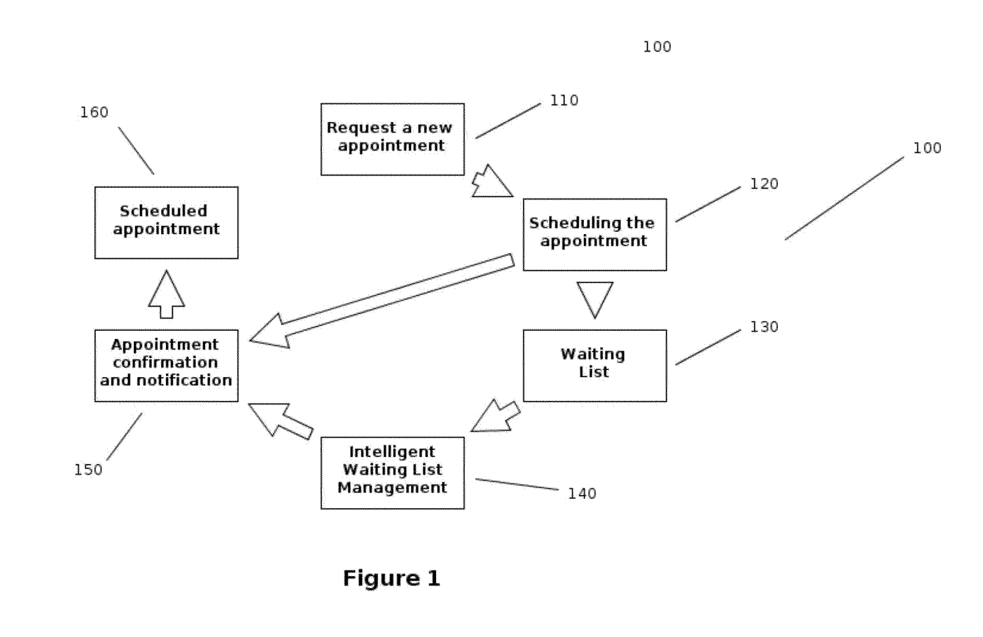

Referring to FIG. 1, the method for intelligent management of appointment 100 waiting list may comprises at least one step, such step may be requesting a new appointment 110, scheduling the appointment 120, adding the name and information of the customer on a waiting list 130, managing an intelligent waiting list 140, confirming and notifying the appointee 150, having the appointment scheduled 160.

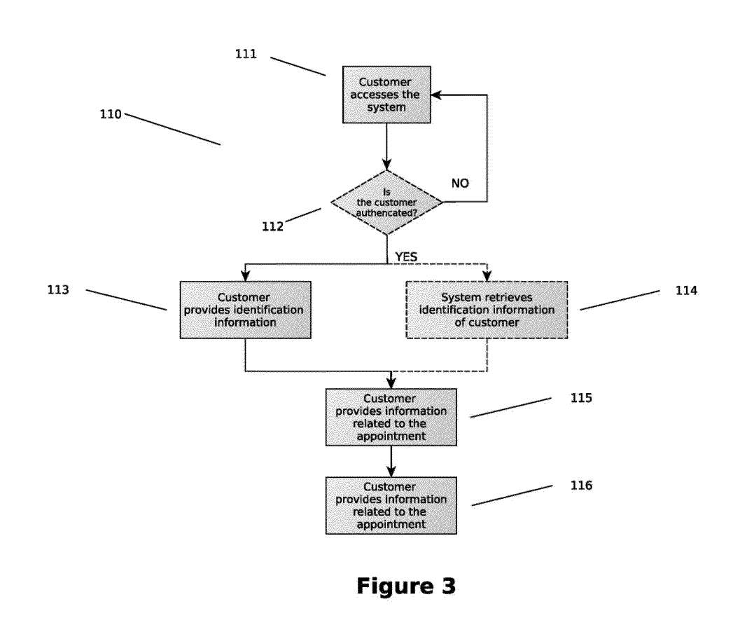

Now referring to FIG. 3, a customer may request a new appointment to a service provider 110 through the system managing appointments and waiting lists. The system must be accessed by the customer through a graphical user interface of a device 111, such as a desktop or laptop computer, a smart or mobile phone or tablet, or through communication means, such as a phone call, an email or an SMS. Such graphical user interface may include a desktop or web based interface, an interface for smart phone or an automated answering system. The system may ask the customer to identify itself through an authentication service 112 such as providing a unique identifier and a secret password, through a combination of alphanumerical characters or through any other authentication method. Through such graphical user interface, the customer must provide identification information 113, such as name, social security number, insurance information, birth day or any other information required for identification. The identification information may be stored within the system and be retrieved from system 114. The customer must also provide information related to the appointment requested 115, such as the concerned service and the preferred time and date of the appointment. Following the validation of such information, the customer submits the request through the device or the communication mean 116. A customer may request many appointments for the same or for many different services through one submission. Such appointments may be requested within one day or spreading within multiple days. In the event where the customer requests many appointments in a single request, the customer may specify the dependencies between the different appointments. Furthermore, the system shall overwrite the dependencies specified by the customer based on predefined and configurable rules of dependencies between the different offered services of the service provider.

Also, the system may allow a customer to submit constraints such as, but not limited to schedule restrictions, time of the day restriction or any other restrictions. The system will use the submitted restrictions as input to the scheduling process of an appointment to a customer. Such constraints may be applied to the service provider schedule. As an example, a medical clinic, acting as a service provider, may add a restriction limiting the availability of a physician on Thursday and Wednesday mornings. Furthermore, the constraints may be applied with one or more conditions or parameters, such as, but not limited to, having one or more constraints applying to a specific customer or to a group of customers, having one or more constraints applying to a type of appointment, requiring a customer to schedule a following appointment within a specific period of time or at a specific frequency or any other parameters or conditions for specific or grouped appointments.

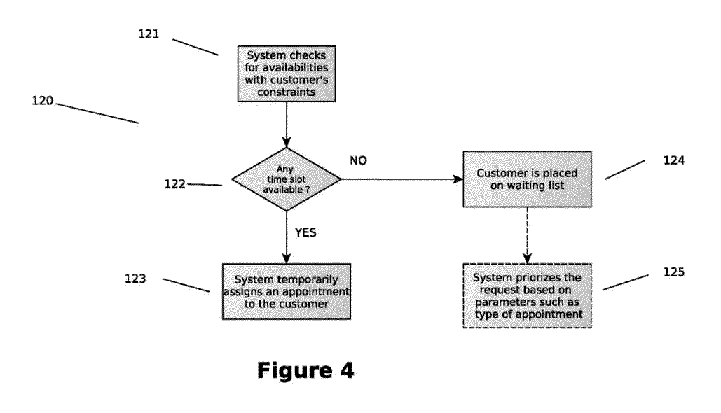

Now referring to FIG. 4, on reception of a request for an appointment from a customer, the system tries to schedule an appointment 120. The system uses the constraints submitted by the customers as argument and determines through one or many algorithms the availabilities of the service provider 121. The system may use other parameters such as customer or service provider's preferences as argument in order to prioritize or manage the customers on the waiting list. On completion of the determination of availabilities, the system must test the resulting availabilities 122. In the event where no resulting availabilities are found, the system places the customer on an intelligent waiting list 124. The system may prioritize the appointment requests based on different parameters 125, such as the type of appointment, the number of appointments required or any other related parameter, such as the priority level, the initial appointment date or the dependencies between the different services of the service provider. If at least one available appointment exists, the system may temporarily or permanently assigns the customer to an appointment 123.

Referring back to FIG. 1, a customer may be added to an intelligent waiting list 130.

In another embodiment, a customer or a physician could request a place on the intelligent waiting list through an interface connected through a network, such as a local area network (LAN), a WAN or the Internet or through an automated telephone system, such as an automated messaging service or voice mail system.

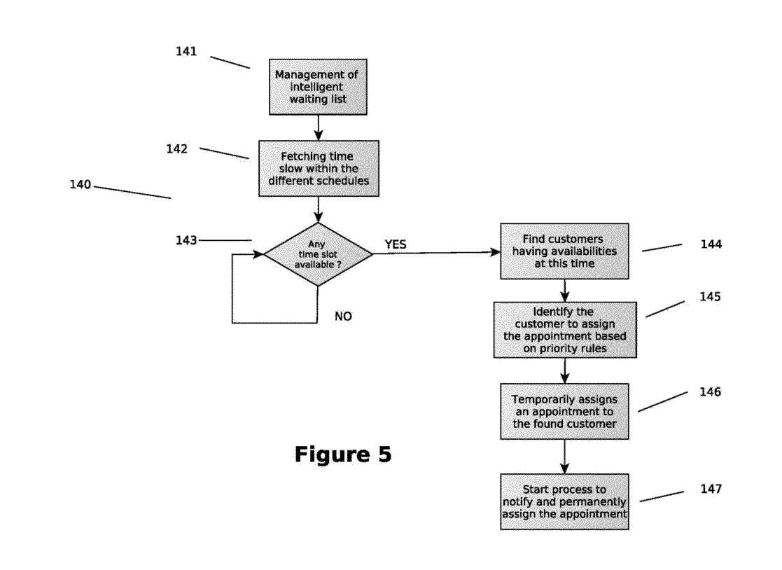

Referring now to FIG. 5, the intelligent waiting list is managed by the system in order to automatically assign appointments to customers present on the waiting list 140. The system fetches the available time slots within one or many schedules of the service providers 142. The system analyzes each found time slot and tests if the time slot is available 143. A time slot may be made available from a cancellation or from new operation hours of the service provider. For every available time slot, the system finds the customers having availabilities during this time period 144. From the list of customers, the system may use priority rules in order to determine a customer to assign an appointment 145. The system then assigns an appointment to the selected customer 146, removes the customer from the waiting list and starts the process to notify and permanently assigns the appointment 147. A unique identifier such as an alphanumerical string or a number may be associated with the assigned appointment.

Now referring back to FIG. 1, the system notifies a selected customer through a communication mean 150, such as an email, a SMS, an automated voice mail or phone call or any other communication means. The communication means may differ following the parameters such as the degree of urgency of the appointment, the personal preferences of the customer, the date or time of the appointment to be assigned or any other parameters influencing the choice of the communication mean. Over time, the system shall adapt the used communication mean based on the parameters and/or on different metrics collected over time, such as the time of a customer to confirm an appointment, the number of successful confirmations by communication mean and any other metric information allowing the system to select the most effective communication mean.

On reception of the notification through the selected communication means, the customer has to confirm the acceptation or refusal of the automatically assigned appointment. The confirmation may be executed using the same communication means or any other communication means made available by the system. As example, a customer may be notified by email of an appointment, the customer may then confirm the acceptation or refusal of such appointment using the automated phone system. For security purpose, the system may ask the customer to authenticate itself by entering the unique identifier associated with the appointment or any unique identifier. If the customer provides a refusal confirmation or does not provide a confirmation to the assigned appointment within a predetermined period, the system cancels the temporarily assigned appointment and places the customer on the intelligent waiting list. The time period is made available and will be assigned to another available customer. A customer placed on the waiting list may or not be placed at its prior position on the waiting list based on different parameters such as the number of prior refusals, the urgency of the appointment or the number of required appointments.

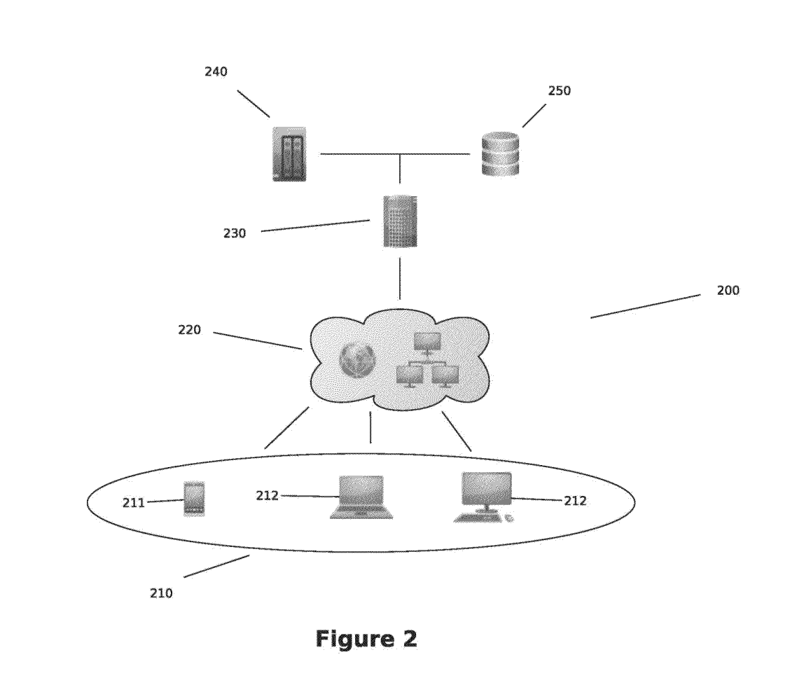

On reception of the confirmation of acceptance of the assigned appointment, the system permanently assigns the appointment to the customer 160. Following the assignation of an appointment, if the appointment is cancelled, whether by the customer or the service provider and if the customer was already on the waiting list, the customer is placed back on the waiting list at his prior or initial position. The system may place the customer at another position within the waiting list based on different parameters such as the number of prior refusals, the urgency of the appointment, the number of required appointments or the number of cancellations. Referring to FIG. 2, the system for intelligent management of appointment is shown 200. The said system comprises at least one client device 210, a communication network 220, at least one web server 230 communicating with at least one application server 240 and with at least one data source 250.

The client device 210, such as a desktop or a laptop computer, a smart phone, a tablet or a mobile phone, comprises a graphical user interface, a processor, a random access memory device, a network card and at least one data source. In another embodiment, the client device may also be embodied as a conventional phone communicating through a phone network. In this embodiment, the customer uses a conventional phone, including a mobile phone or a smart phone, to call an automated voice mail system, an automated phone system or, if needed, a person acting as a receptionist.

The communication network 220, such as a local area network (LAN), a wide area network (WAN), the Internet, a telephone network or any telecommunication network, comprises a mean for a client device to connect or to access the web server 230. The web server comprises a physical computer having a network communication mean and software acting as a web server such as Apache Web Server or Microsoft IIS.

The web server 230 acts as a gateway to at least one application server 240 and at least one data source 250. The application server comprises a physical computer a physical computer having a network communication mean and software acting as an application server. The data source 250, such as a relational database, an XML file, a binary file or any other mean of organized storage device, stores the information required by the system 200, such as the customer's preferences, the information related to appointments, the schedules of the service provider and the general configuration of the system 200. The web server 230, the application server 240 and the data source 250 may be installed on a single physical server or be installed on at least two physical servers.

Referring back to FIG. 3, in another embodiment, a customer may request a new appointment to a service provider 110 or submit any request similar to requests 116 through the service provider's customer service representative. Such customer service representative may also initiate one or more requests through the system based on the instructions received by the customer. The providers' customer representative would then accesses the system through a graphical user interface of a device 111, such as a desktop or laptop computer, a smart or mobile phone or tablet, or through communication means, such as a phone call, an email or an SMS.

In other embodiments, the system may be used for managing other intelligent waiting lists. In one of those possible embodiments, the system may manage one or more intelligent list to allocate work shifts for on-call employees within one or more organizations. In such embodiment, an employee would indicates his available time periods within a time duration, such as a week, two weeks or a month, to the system through a graphical user interface such as a desktop or web based interface, an interface for smart phone or an automated answering phone system.

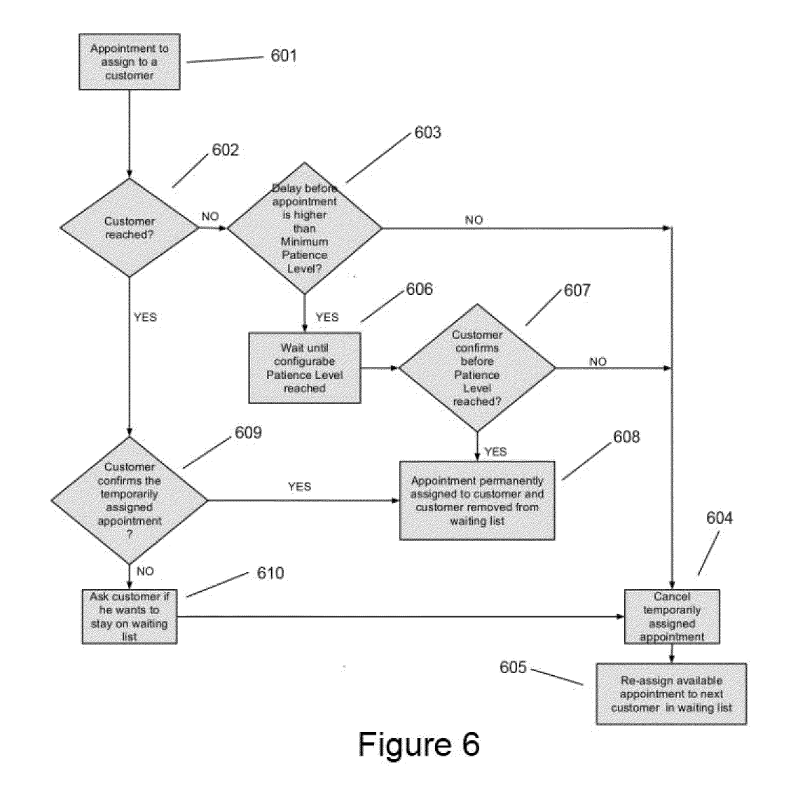

Now referring to FIG. 6, an embodiment allowing the method to apply a patience level to the system and method for managing intelligent waiting lists is presented. In such method, the system or method must be at the step of assigning an appointment to a customer 601. The appointment may be assigned or temporarily assigned after a cancellation of a scheduled appointment, a rescheduling of an existing appointment or the creation of a new appointment. The system checks if the customer has been contacted by a method of communication 602, such as email, telephone or any other communication method.

In the event where the system or the service provider did not contacted the customer 602, the system calculates the period of time from the current time to the appointment assigned to the customer. The calculation may be completed at a predefined or variable frequency. If the calculated period of time is superior to a minimum patience level, the system cancels the temporarily appointment 604. Every time the cancellation of an appointment 604 triggers the system to create an available timeslot which may be assigned to customer on the at least one waiting list 605.

The patience level is a definable parameter of the system and may be configured to ensure that the degree of patience is adapted to the business of the service provider. The patience level varies as a function of the delay between the period of time left and the found time slot. As an example, the patience level may be zero for an appointment to be assigned on the same day. In this case, the temporary appointment of a customer will be cancelled if the customer is not reached 602 immediately. However, the patience level will be greater if an appointment is to be assigned in 10 days. In this event, the time to respond of the contacted customer shall be longer, such as 2 days. After the time to respond has elapsed, in this case 2 days, the system will cancel the temporary appointment 604. A patience level may be defined for the system or may be specific for a specific establishment of the service provider.

If the calculated period of time is equal or inferior to the patience level 603, the system maintains the temporarily assigned appointment within the system until the calculated period of time becomes superior to the patience level 606. As long as the calculated period remains inferior or equal to the patience level 606, the system checks if the customer confirmed the temporarily assigned appointment 607. In the event where the customer fails to confirm the appointment 607 before the patience level is reached, the system will cancel the temporary appointment 604. If the customer confirms the temporary appointment before the patience level is reached 607, the system permanently assign the appointment to the customer and remove the customer from the waiting list 608. To permanently assign the appointment to the customer 608, the system writes the required information to the data source 250 (shown in FIG. 2).

In the event where the system or the service provider succeeds in reaching the customer 602, the customer must confirm that the temporary appointment may be permanently assigned to the system 609. The confirmation of the customer may be executed by any method of interactive communication such as clicking on a hyperlink inserted in an email, send a SMS message, using a telephone or using a mobile application. On confirmation, the system will permanently assign the appointment to the customer 608. If the customer is not available and does not confirm the appointment 609, the system will ask the customer if he wishes to remain on the waiting list 610 without losing its priority. If the customer refuses to remain on the waiting list 610, the system will cancel the temporary appointment.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A system having a computer system adapted to intelligently manage at least one appointment waiting list comprising:
a) a communication network;
b) at least one application server;
c) at least one web server configured to communicate with at least one application server over the communication network;
d) at least one client device configured to communicate with the at least one web server over the communication network;
e) at least one data source configured to store waiting list information;
wherein the system is configured for:
a customer to request the scheduling of at least one appointment;
scheduling the at least one appointment;
storing the information related to the customer in the at least one data source;
managing an intelligent waiting list;
confirming and notifying the customer;
scheduling the appointment.

2) A system to intelligently manage at least one appointment waiting list as described in claim 1, wherein the client device comprises a graphical user interface, a processor, a random access memory device, a network card and at least one data source.

3) A system to intelligently manage at least one appointment waiting list as described in claim 2, wherein the client device is a phone communicating through a phone network.

4) A system to intelligently manage at least one appointment waiting list as described in claim 1, wherein the communication network is the Internet.

5) A system to intelligently manage at least one appointment waiting list as described in claim 1, wherein the system is configured to allow the customer to submit constraints on one or more appointments and uses the constraints as input to the scheduling of the appointment.

6) A system to intelligently manage at least one appointment waiting list as described in claim 1, wherein the system is configured to allow the service provider to submit at least one constraint relating to the appointment scheduling process and uses the at least one constraint as input to the scheduling of the appointment.

7) A system to intelligently manage at least one appointment waiting list as described in claim 6, wherein the at least one constraint is applied with one or more conditions.

8) A system to intelligently manage at least one appointment waiting list as described in claim 1, wherein the web server, the application server and the data source are running on a maximum of two physical servers.

9) A system to intelligently manage at least one appointment waiting list as described in claim 1, wherein the system is configured to calculate the delay between the period of time left and the found time and to compare the said delay to a patience level before permanently assigning an appointment to a customer.

10) A system to intelligently manage at least one appointment waiting list as described in claim 9, wherein the patience level is a configurable parameter of the system and is configured to vary as a function of the said delay.

11) A system to intelligently manage at least one appointment waiting list as described in claim 10, wherein the patience level is specific to a service provider.

12) A method for intelligent management of appointment waiting list, the method comprising the steps to:
a) allow a customer to request a new appointment from a service provider;
b) schedule a appointment if an available time slot of the service provider is found;
c) add the customer to a waiting list if no available time slot of the service provider is found;
d) manage an intelligent waiting list;
e) notify the customer through a communication method;
f) wait for the acceptation or refusal of the customer concerning the automatically assigned appointment;
g) assign the appointment.

13) A method for intelligent management of appointment waiting list as described in claim 12 wherein the step to request a new appointment is realized by contacting an employee of the service provider, wherein the said employee is requesting the new appointment through a graphical user interface of device.

14) A method for intelligent management of appointment waiting list as described in claim 12, wherein the step the customer requests a new appointment through a graphical user interface of a device by providing identification information and appointment information.

15) A method for intelligent management of appointment waiting list as described in claim 12, wherein the method further comprise the step for a customer to request a new appointment on a waiting list using an interface connected through a communication network.

16) A method for intelligent management of appointment waiting list as described in claim 15, wherein the customer must be identified through an authentication service.

17) A method for intelligent management of appointment waiting list as described in claim 12 wherein the step the customer requests more than one new appointment.

18) A method for intelligent management of appointment waiting list as described in claim 17, wherein the customer provides dependencies between the different appointments.

19) A method for intelligent management of appointment waiting list as described in claim 12, wherein the step to schedule an appointment further comprises the steps to:
a) use the constraints submitted by the customer as argument of the scheduling;
b) determine the at least one available time slot of the service provider through one or many algorithms;
c) determine at least one customer having availabilities during the at least one available time slot.

20) A method for intelligent management of appointment waiting list as described in claim 12, wherein the communication method differs based on at least one parameter.

21) A method for intelligent management of appointment waiting list using a patience level for a temporary assigned appointment, the method comprising the steps to:
a) schedule a temporary appointment to a customer if an available time slot of the service provider is found;
b) add the customer to a waiting list if no available time slot of the service provider is found;
c) notify the customer of an available time slot through a communication method;
d) calculate the delay between the period of time left and the found time slot;
e) validate if the calculated delay is superior to the patience level;
f) wait for the confirmation or refusal of the customer while the delay between the period of time left and the found time slot is inferior or equal to the patience level;
g) permanently assign the temporary appointment on reception of the confirmation of the customer;
h) wait for acceptation or refusal of the customer concerning the temporary appointment;
i) assign the appointment.

22) A method for intelligent management of appointment waiting list using patience level as described in claim 21, wherein the method further comprises the steps to:
a) cancel a temporary appointment triggering the creation of an available timeslot which may be assigned to customer on the at least one waiting list;
b) ask the customer to remain on at least one waiting list on refusal of the customer;
c) validate if the customer has been contacted through a communication method.

23) A method for intelligent management of appointment waiting list using patience level as described in claim 21, wherein the patience level varies as a function of the delay between the period of time left and the found time slot.
